(19) United States
(12) Patent Application Publication
(10) Pub. No.: US 2012/0102674 A1
(43) Pub. Date: May 3, 2012

(54) ADJUSTABLE HINGE

(75) Inventors: Steven King, Victoria (AU); John Mythen, Victoria (AU)

(73) Assignee: GRYFFIN EPSS PTY LTD, Victoria (AU)

(21) Appl. No.: 13/202,066

(22) PCT Filed: Feb. 22, 2010
(86) PCT No.: PCT/AU10/00200

§ 371 Date: Oct. 19, 2011

(30) Foreign Application Priority Data
Feb. 20, 2009 (AU) 2009900715

(51) Int. Cl. E05D 7/04; E05D 11/04

(52) U.S. Cl. 16/237; 16/248; 16/247

(57) ABSTRACT

A hinge comprising:
a support part for attaching to a support;
a load part for attaching to a load;
and a pivot formed therebetween;
wherein the support part and the load part are independently adjustable under load in at least one direction relative to one another.

### RELATED APPLICATION

This application claims priority from Australian Provisional Patent Application No. 2009900714 in the name of Gryffin EPSS Pty Ltd, which was filed on 20 Feb. 2009, entitled “Hinge Device and Method of Adjustment” and the specification thereof is incorporated herein by reference in its entirety.

### FIELD OF INVENTION

The present invention relates to the field of pivotable load bearing devices. In one form, the invention relates to a hinge. In one particular aspect the present invention is suitable for use as a relatively heavy duty gate hinge.

It will be convenient to hereinafter describe the invention in relation to a gate hinge attached to a post, however, it should be appreciated that the present invention is not so limited and can be used for a multitude of other applications including as a door hinge, or hinge for any other suitable load attached to any convenient support.

### BACKGROUND ART

Although it is assumed that gate post(s), when installed, are installed relatively plumb to each other, subsequent ground movement can result in the post(s) moving out of line. This in turn results in misalignment of the gate and post(s) and consequent problems with the gate closing and also problems with the locking system, such as due to misalignment.

Gate posts and gate frames also tend to flex from induced weight when installed. The general method of adjusting a hung gate is to lift/jack the extreme end of the gate frame to its required position and then adjust the hinge either by loosening bolts holding the hinge to the post. Once adjusted, the support is removed and weight is again transferred to the frame and post(s), possibly requiring repeated adjustment until the required result is achieved in an iterative fashion.

A further problem exists when the hinge is welded to the gate. Once the weld takes hold, further adjustment is not possible, without grinding away the original weld, re-adjusting the hinge and re-welding the hinge. This is labour intensive, the finished work does not provide a good visible appearance, and also the grinding and rewelding softens and thus weakens the steel of the hinge and/or gate post.

Another problem exists if and when adjustment at a future date is necessary, such as to compensate for effects of prolonged stress on sections and also further ground movement affecting gate and post(s) alignment.

Furthermore, a number of prior art hinges are problematic because they must be attached to the side of the post and sit between the post and the gate stile sections thereby increasing the gap between the post(s) and gate.

Another problem with known hinges is the eventual corrosion to the surfaces of the hinge caused by exposure to weather. Hinges having anti-corrosion protection, for example, by being painted, are less susceptible to wear but the protective paint coating interferes with working clearances on the moving hinge parts. Even when coated the load bearing surfaces will eventually wear leading to vulnerability to corrosion on those surfaces.

One prior art hinge consists of a plate with vertical ridges that bolts to the post and the hinge plate also with vertical ridges which bolts through it and gives lateral movement. The gate stile section of this hinge is similar with horizontal ridges that allows vertical adjustment, but these are considered light weight hinges (gates under 100 kgs) rated for gates weighing no more than 25 kgs and do not allow the gates to be adjusted under load.

Some known heavy duty hinges can be adjusted under load but are designed to be fitted centrally between the post and gate frame and therefore require a significant gap between the post and gate, and prevent the gate opening 180°.

Accordingly, apart form addressing any other deficiencies with related art hinge mechanisms, it would be desirable to provide a heavy duty hinge that overcomes problems in the prior art.

### SUMMARY OF INVENTION

In a first aspect of the invention there is provided a hinge comprising: a support part for attaching to a support; a load part for attaching to a load; and a pivot formed therebetween; wherein the support part and the load part are independently adjustable under load in at least one direction relative to one another.

Typically the support will comprise a post, such as a fence post but may alternatively comprise part of a wall or other construction.

Typically the load will comprise a gate, door or other barrier for closing an opening in a fence, building or other construction.

In another aspect of the invention there is provided a hinge comprising:

a support part for attaching to a support; and

a load part for attaching to a load, the support and load parts being pivotable relative to each other at a pivot,

wherein the support and load parts are linearly displaceable relative to each other at the pivot under load.

The pivot preferably comprises a shaft rotatable within a sleeve. The shaft and sleeve each form a part of either the support part or the load part. The shaft and sleeve are axially displaceable relative to one another.

More preferably, the shaft forms part of the support part and the sleeve forms part of the load part and the shaft and sleeve are displaceable in a vertical direction.

A ball bearing is preferably located inside of the sleeve at an end of the shaft and is seated in a recess at the top end of the shaft.

An adjustable spacer axially separates the sleeve and shaft. The adjustable spacer extends through an end of the sleeve to axially separate the sleeve and shaft by bearing against the ball bearing. Typically, the spacer is a bolt extending through the upper end of the sleeve.

The shaft may have a stepped recess into which a locking member extends radially through the sleeve to prevent separation of the shaft and sleeve.

The support part preferably includes a movable plate that is linearly adjustable in a horizontal direction relative to the support thereby adjusting the horizontal position of the pivot and the load part. The movable plate is urged to move by screwing a threaded member relative to a peg fixed to the support.

In still another aspect of the invention there is provided a method of adjusting the relative position between a support and a load between which a hinge as described hereinbefore is mounted, including adjusting the vertical position of the hinge by actuating an adjustment mechanism to vertically displace the support part relative to the load part.

In still another aspect of the invention there is provided a method of adjusting the relative position between a support and a load between which a hinge as claimed in any one of the preceding claims is mounted, including adjusting the horizontal position of the hinge by loosening fasteners mounting the support part to the support; and actuating an adjustment mechanism to urge a movable plate of the support part in a horizontal direction moving relative to a peg fixed relative to the support.

The hinge may be used in a variety of applications. It is understood that the support may comprises one of: a post; a fence post; a wall or similar construction; The load may comprise one of; a gate; a door; a barrier for closing an opening in a fence, building or similar construction.

It is understood that a hinge system using the described hinges could be used for hinging a load to a support comprising a plurality of the hinges as disclosed on the same load.

Other aspects and preferred forms are disclosed in the specification and/or defined in the appended claims, forming a part of the description of the invention.

It should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Embodiments of the present invention will now be described by way of example with reference to the accompanying drawings, wherein:

FIG. 1 illustrates a hinge according to an embodiment of the present invention;

FIG. 2 illustrates a schematic side view of the hinge illustrated in FIG. 1; and

FIG. 3 illustrates a schematic plan view of the hinge.

### DETAILED DESCRIPTION

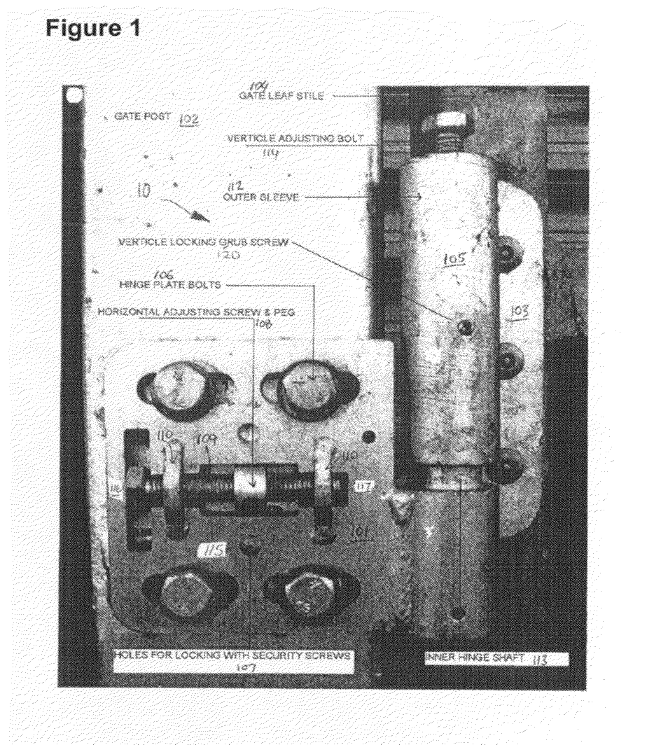

A hinge 10 according to an embodiment of the present invention is illustrated in FIG. 1. The hinge includes a first or support part which comprises at least a post plate 101 which is releasably coupled to a support such as post 102, and a second or load part which comprises at least gate plate 103, which is releasably coupled to a load such as gate and/or gate frame 104, preferably the gate stile as shown, and a pivot part 105 between the post plate 101 and gate plate 103 parts, the pivot part 105 being adapted to provide pivotal movement between the post plate 101 and gate plate 103. The pivot part 105 comprises a combination of a first coupling that forms part of the support part and a second coupling that is formed as part of the load part of the hinge.

The post plate 101 may be affixed to the gate post 102, whether or not the fixing is releasable or permanent, using fasteners shown as hinge plate bolts 106. In FIG. 1, four bolts are shown for the purpose of fastening. Additional, but optional, provision such as holes 107 may be made for security fasteners, such as for example, security non-reversible screws that may be added after final installation, alignment etc.

As shown in the embodiments illustrated in the accompanying figures, the hinge may be bolted to either the front or rear of a gate post 102, which as noted provides the advantage of allowing for a smaller gap between the post 102 and the gate frame 104. Moreover, the load or stress on the retaining bolts 106 is less if the hinge is fastened to the front or rear of the post 102 as opposed to bolting into the centre of the post 102 on its side in line with the gate frame. While it is preferable to attach the hinge to the front or rear of a post, the hinge would still function well attached to the centre of a post.

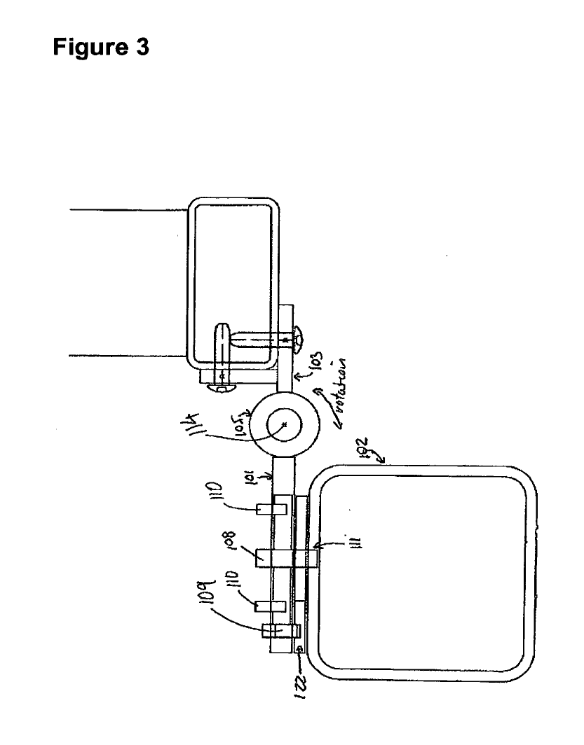

A horizontal adjustment peg 108 is also provided. The peg 108 contacts the post 102 so that it is fixed or anchored to the post. As can be seen in FIG. 3, for example, the peg 108 sits in a recess or hole 111 in the post 102.

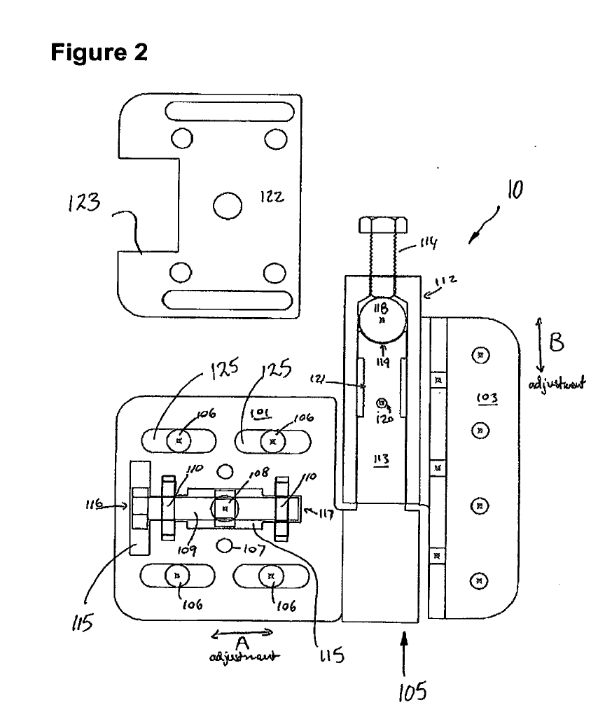

Referring again to FIG. 1, the peg 108 also contacts (in a suitable manner) a first, horizontal adjustment bolt 109. Straps 110 serve to hold and confine the adjustment bolt 109 relative to the post plate 101 of the hinge. The adjustment peg 108 has an internally threaded opening to threadingly engage with and receive the adjustment bolt 109. When the bolt 109 is rotated, the bolt 109 bears against one of opposite end surfaces 116 and/or 117 of a void 115 in post plate 101, in which bolt 109 lies and urges the post plate to move in the direction the bolt is displaced. Void 115 is vertically wide where it houses the head of bolt 109 for the purpose of accommodating a spanner, or similar tool, to rotate the head of bolt 109. In the case of adjusting the post plate 101 to the left as shown in FIG. 1, the head of adjustment bolt 109 contacts with and pushes surface 116; and in the case of adjusting the post plate 101 to the right, the head of adjustment bolt 109 contacts with and pushes surface 117. In this case the underneath flange of the head of the bolt 109 also contacts and pushes the plate 101 at the edge of void 115 adjustment to the bolt head. Because the peg 108 is fixed against any movement, the rotation causes the bolt 109 to move in a linear direction thereby urging or forcing the post plate 101 to move with the bolt. As a result, there is provided relatively easy adjustment in the horizontal planes between the gate and gate post 102 in the direction illustrated by Arrow A in FIG. 2. The horizontal range of movement will vary depending on the size of the hinge and the bolt. In one embodiment the range of movement is 25 mm.

Thus, for initial fitting of a gate to a gate post using the hinge of the present invention, the post plate 101 should be secured to the post 102. This can be done by aligning the peg 108 of the post plate 102 with a corresponding recess 111 in the post 102. The post plate 101 has its plate bolts 106 installed, but not yet securely tightened. Post plate 101 has slots 125 for receiving plate bolts 106 and for allowing relative movement between bolts 106 and post plate 101 sufficient to accommodate the range of movement of the support part.

The gate plate 103 is coupled to the gate (not shown) by attachment to the gate stile 104 by bolts, welding or other suitable means. The gate plate 103 is then coupled to the post plate 101 by assembling the first and second couplings of the pivot part 105. Typically assembly is carried out by lifting the gate, its gate plate and the second coupling onto the post plate 101 and onto the first coupling.

The pivot part 105 has an outer sleeve 112 and an inner hinge shaft 113. In the embodiment shown, the outer sleeve 112 is the second coupling and is attached to the gate plate 103 connectable to the gate stile 104, and the inner shaft is the first coupling and is attached to the post plate 101 connectable to the gate post 102. However, in an alternative embodiment, the outer sleeve 112 may be coupled to the post plate 101 and the inner shaft 113 may be coupled to the gate plate 103, provided another arrangement is introduced to support the gate, and specifically the inner shaft, on the outer shaft.

The pivot part also allows for vertical adjustment and has a locking member, specifically grub screw 120. FIG. 2 illustrates in more detail the hinging mechanism of the pivot part 105. The outer sleeve 112 connects with the inner shaft 113 via a ball bearing 118. The bearing 118 sits in a corresponding machined bearing seat or recess 119 on the top of inner shaft 113 and bears the weight of the gate (namely the load) through outer sleeve and specifically through a second, vertical adjustment bolt 114. By this arrangement, the ball bearing 118 is in the weight bearing axis of the hinge. In conjunction with the machined recess 119 in the top of the internal hinge shaft 113, the bearing 118 serves to centralize the shaft in the outer hinge sleeve 112 creating a true bearing action and thereby reducing shaft-sleeve surface wear. As a result, vertical adjustment is possible under load in the direction of Arrow B in FIG. 2, with the weight of the gate bearing upon the ball bearing 118, and via surface 119 to inner shaft 113, post plate 101 and gate post 102 (FIG. 1). There are many benefits in being able to adjust under load; for example, for correct alignment for visual effect and more complex locking systems can be more simply achieved.

Another advantage of the embodiment illustrated in FIG. 2 is that the ball bearing 118 is covered by sleeve 112, and this will provide some protection from external (weather) elements, and accordingly provide prolonged use of the hinge of the present invention.

The vertical adjustment bolt 114 lies axially of the sleeve 112 and shaft 113 and in effect, adjustably spaces the sleeve and shaft and provides a vertical adjustable bias by allowing relative movement between the bearing 118 and the outer sleeve 112. The vertical adjustment bolt is basically a spacer to separate the distance between the ball bearing 118 and the sleeve 112. Other types of spacers could be used instead of a bolt, such as a cam arrangement or a slidable pin lockable at varying insertion depths.

Grub screw 120 extends radially into the sleeve 112 to interact with a stepped, turned recess 121 and bear against inner shaft 113 to provide a barrier or a stop to prevent separation of the post plate 101 and gate plate 103 of the hinge so that the gate cannot be lifted off the hinge. Preferably, the axial length of the stepped recess equates to the length defining the range of vertical movement of the hinge. In the embodiment described above where the horizontal range of movement is 25 mm, the length of the stepped recess may also be 25 mm but can be any suitable size depending on the particular gate application.

The relative position of the gate (not shown) and the post 102 is actuated by horizontal and vertical adjustments of the present hinge. Vertical adjustment is bought about by vertical adjustment bolt 114 to alter the vertical position of the gate, while the arrangement of the peg 108 and bolt 109 may be used to alter the horizontal position of the gate and post 102. It is understood that, under load, adjustment in the horizontal direction may also produce a vertical displacement of the load.

Once the gate and post are adjusted to a desired position, the bolts 106 may be tightened, and the grub screw 120 is tightened to lock the engagement between the gate plate 103 and post plate 101 yet still allow for some vertical displacement between them. As the grub screw 120 is screwed in it engages in the recess 121 in the inner shaft 113. The length of recess 121 allows for vertical adjustment but prevents the outer sleeve 112 from being lifted off the inner shaft 113. It is therefore unnecessary to loosen the grub screw when adjusting the hinge.

If the gate has already been installed on the hinge and post 102, but requires horizontal adjustment, the hinge plate bolts 106 may be loosened, and the adjustment bolt 109 may be rotated in order to move post plate 101 horizontally in relation to peg 108, thus shifting the position of the plate 101 relative to the post 102. The bolts 106 may then be secured again in their corresponding slots 125 once the adjustment is satisfactory. If vertical adjustment is necessary, the bolt 114 may be adjusted in order to alter the vertical position of the gate relative to the post 102.

FIG. 2 also illustrates a backing plate 122 which may be optionally used between the post plate 101 and the gate post 102. The backing plate 122 may be used to provide packing between the gate stile 104 and hinge in order to address gate/post misalignment or to provide a thicker mount for the support part. The backing plate 122 may also serve to provide a relatively smooth surface to assist in the movement of the post plate 101 when the adjustment bolt 109 is being used to move the post plate (laterally) relative to the gate post 102. Backing plate 122 has holes and slots corresponding to receive the bolts 106 and peg 108, and has a cut-out 123 to allow room to wind adjustment bolt 109 with a spanner.

FIG. 3 illustrates more detail of the hinge of the present invention, in plan view. The interaction between the peg 108, and the post 102 can be seen. The rotational movement of the parts 101 and 103 is also shown.

In an alternative embodiment(s), an adjustment mechanism similar to the bolt and peg arrangement 109/108 may be provided in conjunction with the post plate 101 and/or gate plate 103 in order to provide vertical adjustment of the post plate 101 and/or gate plates 103.

The post 102 and gate may be of any shape and/or material. The post may be any structure that supports a pivoting part or may, for example, be a brick, concrete, wooden or composite wall, column, post, or the like. The ‘gate’ may be any pivoting component including a door, window, moveable wall or other barrier. The hinge may also be oriented in a 0°-90° configuration to that illustrated herein so that the pivot is other than about a vertical axis.

In a preferred embodiment, the plates and pivoting parts of the hinge is hot dip galvanized after fabrication and all additional parts including bolts are either hot dip galvanized or are stainless steel. This provides the hinge with a high level of protection and there is no interference of tolerances. The present hinge does not suffer the problem of distorted tolerances due to hot dip galvanizing experienced by prior art devices because the arrangement of the ball bearing seated in seat/recess 119 allows for larger tolerances within the pivot part 105 including between the shaft and sleeve. While it is not possible to completely eliminate wear inside the hinge, the combination of a ball bearing 118 seated in a recess 119 at the end of the internal shaft 113 limits wear to a very small surface area, localised to the area of contact with the ball which is fully enclosed within the outer hinge sleeve 112. This area is filled with grease during assembly. If and when wear in this area becomes a problem, a couple of turns on bolt 114 when in contact with the ball will provide the ball with fresh surface for contact.

It will be appreciated by the person skilled in the art that with the benefit of the functioning of the hinge as described in embodiments herein it will be possible to provide a hinge system for hinging a load to a support in which a plurality of hinges as disclosed herein and positioned appropriately to couple a load to a support may be utilised to provide adjustment of a gate or other load wherein the position of the load relative to the support is adjusted by one or a combination of:

adjusting the position of the first or support part of at least one or more hinges relative to its support, and;

adjusting the position of the second or load part of at least one or more hinges relative to its first or support part.

The adjustment of a combination of a plurality of hinges coupling a load to a support allows for very fine adjustment under load.

Embodiments of the present invention reflect a pivotable device such as a gate hinge, can be adjusted under load because it comprises two parts that are interconnected in a manner that allows them to be independently adjusted orthogonally relative to each other without comprising the relationship of the two parts

Advantages provided by the present invention comprise the following:
Relatively easy adjustment in the horizontal and/or vertical planes;
Enables adjustment while under load;
By being able to adjust under load, correct alignment for visual effect and complex locking systems can be more simply achieved;
Enables ease of adjustment at future dates to compensate for effects of prolonged stress on sections and also ground movement affecting alignment of the support.
Provides the option of surface attachment to front or rear of a support, and gate stile or the like;
Allows the gap between support and load, such as a gate stile or the like to be relatively small;
When the pivot comprises a ball bearing in its weight bearing axis, the ball bearing is seated in a machined recess in the top of the pivot shaft, this also serves to centralize the shaft in the pivot sleeve creating a true bearing action and reducing shaft-sleeve surface wear and enabling total hot dip galvanizing of the complete hinge unit.
The pivot shaft and sleeve are locked after installation by a locking means such as a grub screw engaging in a turned recess in the shaft, thus preventing the load, such as a gate, from being lifted off the pivot shaft.
Allows for a full 180° arch enabling the load to swing from a closed position to a fully open position, relatively flat against the attached fence, wall or the like, and any intermediate position.
One section of the hinge may be attached to a gate stile or the like with security non-reversible high tensile self tapping screws in both planes, to allow for complete hot dip galvanizing, although the hinge may otherwise be welded, if required.
Supports such as posts and loads such as gate leaves may be supplied with (separated) parts of the load bearing device attached and after installation of the posts, the separated hinge parts may be again coupled together by attaching the gate and post. In this case, the first part comprises a pivot plate section that may be attached to the posts and may be pre-adjusted in a ‘neutral’ position to allow for adjustment in a direction transverse to the post.
Although it is assumed that when two supports such as posts are used, they will be installed plumb to each other, subsequent ground movement could result in the supports moving out of line resulting in misalignment of the central leaf stiles and possible problems with the locking system. To correct this, backing plate packers may be installed although longer fixing plate bolts may be required;
When the support comprises a post, one part of the hinge can be attached to the front or rear of a gate post, thus reducing stress upon retaining fasteners as opposed to attaching the hinge to the side of the post in line with the gate frame;

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly any such discussion should not be taken as an admission that any of the material forms part of the prior art base or the common general knowledge in the relevant art in Australia, or elsewhere, on or before the priority date of the disclosure and/or claims herein.

1.-16. (canceled)

17. A hinge comprising:
a support part for attaching to a support;
a load part for attaching to a load;
and a pivot formed therebetween, at which the support and load parts are pivotable relative to each other;
wherein the support part and the load part are linearly displaceable relative to each other at the pivot when under load.

18. The hinge claimed in claim 17, wherein the support and load parts are linearly displaceable under load in orthogonal directions relative to one another.

19. The hinge claimed in claim 17, wherein the pivot comprises a shaft rotatable within a sleeve, the shaft and sleeve each forming part of either the support part or the load part, and the shaft and sleeve are axially displaceable relative to one another.

20. The hinge claimed in claim 19, wherein the shaft forms part of the support part and the sleeve forms part of the load part and the shaft and sleeve are displaceable in a vertical direction.

21. The hinge claimed in claim 19, wherein a ball bearing is located inside of the sleeve at an end of the shaft.

22. The hinge claimed in claim 21, wherein the ball bearing is seated in a seat at the end of the shaft.

23. The hinge claimed in claim 19, wherein an adjustable spacer axially separates the sleeve and shaft.

24. The hinge claimed in claim 21, wherein an adjustable spacer extending through an end of the sleeve axially separates the sleeve and shaft by bearing against the ball bearing.

25. The hinge claimed in claim 23, wherein the spacer is a bolt extending through an end of the sleeve.

26. The hinge claimed in claim 19, wherein the shaft has a stepped recess into which a locking member extends radially through the sleeve to prevent separation of the shaft and sleeve.

27. The hinge claimed in claim 17, wherein the support part includes a movable plate that is linearly adjustable in a horizontal direction relative to the support thereby adjusting the horizontal position of the pivot and load part.

28. The hinge claimed in claim 27, wherein the movable plate is urged to move by screwing a threaded member relative to a peg fixed to the support.

29. A method of adjusting the relative position between a support and a load between which a hinge as claimed in any one of the preceding claims is mounted, including adjusting the vertical position of the hinge by actuating an adjustment mechanism to vertically displace the support part relative to the load part.

30. A method of adjusting the relative position between a support and a load between which a hinge as claimed in any one of the preceding claims is mounted, including adjusting the horizontal position of the hinge by loosening fasteners mounting the support part to the support; and actuating an adjustment mechanism to urge a movable plate of the support part in a horizontal direction relative to a peg fixed relative to the support.
